(19) United States
(12) Patent Application Publication
(10) Pub. No.: US 2019/0272087 A1
(43) Pub. Date: Sep. 5, 2019

(54) Interface filtering method and system

(71) Applicant: HUIZHOU TCL MOBILE COMMUNICATION CO., LTD, Huizhou (CN)

(72) Inventor: Fang XIE, Huizhou (CN)

(73) Assignee: HUIZHOU TCL MOBILE COMMUNICATION CO., LTD, Huizhou (CN)

(21) Appl. No.: 16/344,964

(22) PCT Filed: Dec. 25, 2017
(86) PCT No.: PCT/CN2017/118408

§ 371 Date: Apr. 25, 2019

(30) Foreign Application Priority Data
Dec. 26, 2016 (CN) 201611218463.0

(51) Int. Cl. G06F 3/0484; G06F 3/0482

(52) U.S. Cl. CPC G06F 3/04847; G06F 3/0482

(57) ABSTRACT

A method and a system for interface filtering are disclosed. The method may include: calling a menu display option list according to an operation of a user; according to a setting instruction from the user, selecting a function option for setting information hiding from the menu display option list, and setting a time period of the information to be hidden; redisplaying the page according to the time period of the hidden information set by the user; and saving the time period set for the hidden information, so that the page is displayed according to the above setting information when logging in again. In the method, only the message useful for the user is displayed, which solves the technical problem that the useless message in a chatting tool affects the search for useful information.

### TECHNICAL FIELD

The present disclosure relates to the technical field of mobile terminals, and particularly relates to a method and system for interface filtering.

### BACKGROUND

Nowadays, chatting tools such as WeChat, Facebook, Weibo and the like are used widely. The chat function is typically organized in groups, or discussed within a unit of a topic, and everyone in the group or unit can express his/her opinions. However, people often encounter a lot of useless messages, making it difficult for people to find the useful information. For example, in a class group, when a teacher finishes a sentence, many parents will follow the teacher's post and reply: “Got it,” “Good,” “Thank you teacher,” “Thank you so much,” and many other similar useless messages. As a result, the important information posted by the teacher is quickly buried in those useless messages, and it is cumbersome and time consuming to find the initial post from the teacher again.

Therefore, the current technology in the field needs to be improved and further developed.

### SUMMARY

The present disclosure provides a method and system for interface filtering to address the above-mentioned deficiencies of the current technology in the field, which solves the technical problem that the useless messages in a chatting tool affect the search for useful information. The technical solution disclosed by the present disclosure is set forth below.

In one aspect of the present disclosure, a method of interface filtering is provided. The method may include:

calling a menu display option list according to an operation of a user; (Step A)

according to a setting instruction from the user, selecting a function option for setting information hiding from the menu display option list, and setting a time period of the information to be hidden; (Step B)

redisplaying a page according to the time period of the hidden information set by the user; (Step C) and

saving the time period set for the hidden information so that the page is displayed according to the above setting information when logging in again. (Step D)

In one embodiment, the Step A of the method of interface filtering as mentioned above may include:

receiving a selection instruction from a user, selecting a text information to be operated, and operating a page of the text information; and

calling a menu display option list including all operation functions of the text information when the operation is a preset operation.

In another embodiment, the Step B of the method of interface filtering as mentioned above may include:

popping up a dialog box for setting the hidden information when the function option of information hiding setting in the menu display option list is selected; and

setting a start time stamp and an end time stamp for the information to be hidden in the dialog box according to the user's instruction.

In yet another embodiment, the Step C of the method of interface filtering as mentioned above may include:

hiding the information to be hidden of the time period set by the user; and

redisplaying the text information remaining after hiding.

In yet another embodiment, the step D of the method of interface filtering as mentioned above may include:

saving the start time stamp and the end time stamp set for the hidden information; and

when logging in again, directly calling the time period comprising the start time stamp and the end time stamp, and then going to the Step C.

In another aspect of the present disclosure, a system of interface filtering is disclosed. The system may include:

a calling module configured to call a menu display option list according to an operation of a user;

a time setting module configured to, according to a setting instruction from the user, select a function option for setting information hiding from the menu display option list, and set a time period of information to be hidden;

a page displaying module configured to redisplay a page according to the time period of the hidden information set by the user; and

a storage module configured to save the time period set for the hidden information so that the page is displayed according to the above setting information when logging in again.

In one embodiment, the calling module according to the present disclosure includes:

an operating unit configured to receive a selection instruction from a user, select a text information to be operated, and operate a page of the text information; and

a menu displaying unit configured to call a menu display option list including all operation functions of the text information when the operation is a preset operation.

In another embodiment, the time setting module according to the present disclosure includes:

a dialog box unit configured to pop up a dialog box for setting the hidden information when the function option of information hiding setting in the menu display option list is selected; and

a setting unit configured to set a start time stamp and an end time stamp for the information to be hidden in the dialog box according to an instruction of the user.

In yet another embodiment, the page displaying module according to the present disclosure includes:

a hiding unit configured to hide the information to be hidden of the time period set by the user; and

a redisplaying unit configured to redisplay the text information remaining after hiding.

In yet another embodiment, the storage module according to the present disclosure includes:

a storage unit configured to save the start time stamp and the end time stamp set for the hidden information; and

a time period calling unit configured to, when logging in again, directly call the saved time period comprising the start time stamp and the end time stamp, and then going to the page displaying module.

The present disclosure provides a method and a system for interface filtering. In the method, the useless message is hidden by meaning of a user's setting, and only the message useful for the user is displayed, which thus solves the technical problem in the existing technology that the useless message in a chatting tool affects the search for useful information, so that the user can find the message needed more quickly.

### BRIEF DESCRIPTION OF THE DRAWINGS

FIG. 1 illustrates a flow chart of a method of interface filtering according to an exemplary embodiment of the present disclosure.

FIG. 2 illustrates a flow chart of an exemplary embodiment of the method of interface filtering according to the present disclosure.

FIG. 3 illustrates a structural block diagram of an interface filtering system according to an exemplary embodiment of the present disclosure.

### DETAILED DESCRIPTION

The present invention is described in detail below with reference to the accompanying figures. It is understood that embodiments described herein are merely for the purpose of describing the present invention and are not intended to limit the scope of the present invention.

In a text message, there may be useless information to be filtered, the useless information is found out and hidden through filtering, and only useful information is displayed, so that the user can find the required information more quickly.

FIG. 1 illustrates a flow chart of a method of interface filtering according to an exemplary embodiment of the present disclosure. As shown in FIG. 1, the method of interface filtering may include:

calling a menu display option list according to an operation of a user; (block S1)

according to a setting instruction from the user, selecting a function option for setting information hiding from the menu display option list, and setting a time period of the information to be hidden; (block S2)

redisplaying the page according to the time period of the hidden information set by the user; (block S3) and

saving the time period set for the hidden information so that the page is displayed according to the above setting information when logging in again. (block S4)

In one embodiment, during an operation of a user, the operation should be carried out on one operation object. In the present disclosure, the operation object can be a text information, that is, carry out a corresponding operation on the interface of the text information. The block S1 may include:

receiving a selection instruction from a user, selecting a text information to be operated, and operating the page of the text information, wherein the text information is the content on a chat display interface of a chatting tool, an operation may be performed at a location of any content on the chat display interface, and the operation can be recorded;

calling a menu display option list including all operation functions of the text information when the operation is a preset operation, where: the preset operation can be determined according to user settings, for example, a long press operation can be set as a preset operation. In the case where a user's finger touches the screen of a mobile terminal exceeds a present threshold time, the operation can be determined as a long press operation, and the threshold time may be set as 1 s, 2 s, or the like. The preset operation may also be set as a shape drawn on the screen of a mobile terminal which is a preset shape, or may be set to contact a fixed position of the mobile terminal, and the like . . . .

In an example, the calling function of a long press operation can be executed by the following program code:

<script language=”Javascript”>
If (document.addEventListener)
//Standard event model, register the capture event handler on the
document object
{
Document.addEventListener(“Longpressmessage,” LongpressHandler);
}

//LongpressHandler is a registered event handler for long pressing a message. Of course, it is also possible if a user wants to display the menu in another way. Its purpose herein is to display a menu that lets the user choose the function of hiding a message.

The menu display option list is called up by the user's operation. The menu display option list includes many menu options, and the user needs to make a selection. The present invention is a process of hiding the useless information, and therefore, a function option of the information hiding setting in the menu option is required. The block S2 may include:

popping up a dialog box for setting the hidden information when the function option of information hiding setting is selected in the menu display option list; and

setting a start time stamp and an end time stamp for the information to be hidden in the dialog box according to an instruction of the user.

Whether it is Weibo, WeChat, or other chatting tool, for each of them, each piece of information corresponds to a corresponding time stamp, so a time stamp can be used to uniquely determine the start or end point of the information to be hidden. The purpose of setting a time stamp is to record the start and end points of a page that need to be hidden. If there is no record at the starting point, then the start time stamp is blank, and the current time information is taken as the starting point; the next selected point would be the end point time stamp.

In an example, the timestamp can be set through the following specific code:

Typedef
{
TIME start_timestamp;
TIME end_timestamp;
};

where TIME is the time stamp type for the start and end points; start_timestamp and end_timestamp record the time stamps of the starting point and ending point of the message, respectively.

When the start time stamp and the end time stamp of the information to be hidden are determined, the text information needs to be reprocessed, and the block S3 may include:

when it is determined that the time of a certain piece of text information is within the time period of the information to be hidden, it would be the text information that needs to be hidden, so as information to be hidden within the time period set by the user will be hidden; when the information in the text information belongs to the text information within the set time period, it is determined that the text information is the text information to be hidden, so the text information will be hidden. The set time period is the time between the start time stamp and the end time stamp.

In an example, the determination of whether the time stamp of the file information is within the set time period and the hidden processing of the text information can be implemented by the following code:

Var messagelist = document.getElementsbyclassname(“message”)
//Get the message array of the current page
For (var i=0; i< messagelist.length;i++)
// Traverse each message
{ If (messagelist[i].timestamp > startTime && messagelist[i]<endTime)

// Determine whether the time stamp of each message belongs to

the time period that needs to be hidden
{
Messagelist[i].style.display = “none”;
//If yes, then hide this message

}

}
</script>

The block S3 further includes redisplaying the text information remaining after the hiding.

At this time, the redisplayed text information only includes useful information that the user needs. The user can find the useful information needed more quickly, and does not need to search the entire text information so as to save the time for searching.

In one embodiment, after the operation of hiding the text information is finished, the time stamps used in this operation of hiding can be saved. When the text information is searched again, it can be searched according to the time stamps set last time. It has a memory function and thus does not need a new setting, which is able to further shorten the time for searching the useful information. In an example, the block S4 may include:

saving the start time stamp and the end time stamp set for the hidden information; and

directly calling the saved time period comprising the start time stamp and the end time stamp when logging in again, and then going to the block S3, where the next logging in may be a logging in on the same mobile terminal, or it may be a logging in on another device using the same account number.

In an example, saving the time stamp of the text information can be implemented through the following code:

LocalStorage.message=
{
“start_timestamp”: st,
“end_timestamp”:et
......
}

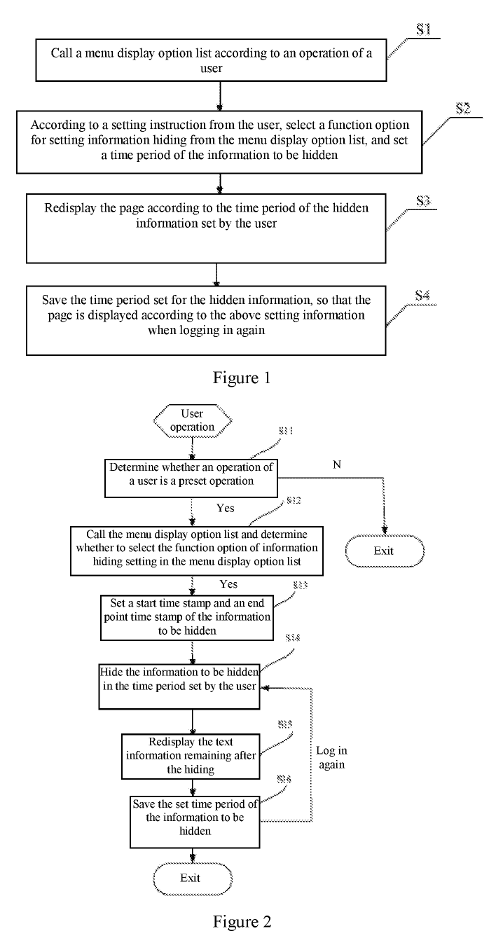

On the basis of the method of interface filtering described above, an exemplary implementation is provided in FIG. 2. FIG. 2 illustrates a flow chart of an exemplary embodiment of the method of interface filtering according to the present disclosure. As shown in FIG. 2, the method includes:

determining whether an operation of a user is a preset operation; (block S11)

calling the menu display option list if it is the preset operation and determining whether to select the function option of information hiding setting in the menu display option list; exiting if it is not the preset operation; (block S12)

setting a start time stamp and an end point time stamp of the information to be hidden when the function option of information hiding setting is selected in the menu display option list; exiting when the function option of information hiding setting is not selected in the menu display option list; (block S13)

hiding the information to be hidden in the time period set by the user; (block S14)

redisplaying the text information remaining after the hiding; (block S15)

saving the set time period of the information to be hidden, and returning to block S14 when logging in again. (block S16)

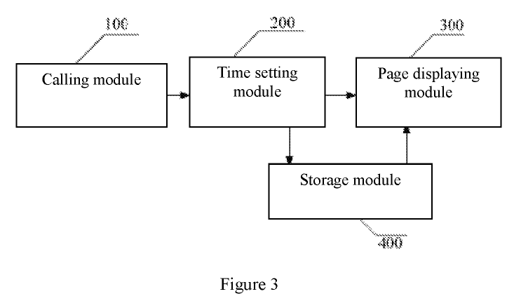

Based on the method for interface filtering provided above, the present disclosure further provides an interface filtering system. FIG. 3 illustrates a structural block diagram of an interface filtering system according to an exemplary embodiment of the present disclosure. As shown in FIG. 3, the system includes:

a calling module 100 configured to call a menu display option list according to an operation of a user, where the detail thereof is as described above;

a time setting module 200 configured to, according to a setting instruction from the user, select a function option for setting information hiding from the menu display option list, and set a time period of information to be hidden, where the detail thereof is as described above;

a page displaying module 300 configured to redisplay a page according to the time period of the hidden information set by the user, where the detail thereof is as described above; and

a storage module 400 configured to save the time period set for the hidden information so that a page is displayed according to the saved setting information when logging in again, where the detail thereof is as described above.

In one embodiment, the calling module 100 according to the present disclosure includes:

an operating unit configured to receive a selection instruction from a user, selecting a text information to be operated, and operating a page of the text information, where the detail thereof is as described above; and

a menu displaying unit configured to, when the operation is a preset operation, call a menu display option list including all operation functions of the text information, where the detail thereof is as described above.

In one embodiment, the time setting module 200 according to the present disclosure includes:

a dialog box unit configured to, when the function option of information hiding setting is selected in the menu display option list, pop up a dialog box for setting the hidden information, where the detail thereof is as described above; and

a setting unit configured to set a start time stamp and an end time stamp for the information to be hidden in the dialog box according to an instruction of the user, where the detail thereof is as described above.

In one embodiment, the page displaying module 300 according to the present disclosure includes:

a hiding unit configured to hide the information to be hidden of the time period set by the user, where the detail thereof is as described above; and

a redisplaying unit configured to redisplay the text information remaining after hiding, where the detail thereof is as described above.

In one embodiment, the storage module 400 according to the present disclosure includes:

a storage unit configured to save the start time stamp and the end time stamp set for the hidden information, where the detail thereof is as described above; and

a time period calling unit configured to, when logging in again, directly call the saved time period comprising the start time stamp and the end time stamp, and then going to the page displaying module, where the detail thereof is as described above.

In summary, the present disclosure provides a method and a system for interface filtering. In the method, the useless message is hidden by meaning of a user's setting, and only the message useful for the user is displayed, which thus solves the technical problem in the existing technology that the useless message in a chatting tool affects the search for useful information, so that the user can find the message needed more quickly.

Certainly, a person skilled in the art can understand that all or part of the processes in the foregoing embodiments may be implemented by a computer program through indicating the related hardware (such as a processor, a controller, etc.), and the program may be stored in a computer readable storage medium, the program, when executed, may include the processes of the various method embodiments as described above. The storage medium described therein may be a memory, a magnetic disk, an optical disk, or the like.

It should be understood that the application of the present invention is not limited to the above examples, and a person skilled in the art may modify or change the above descriptions. However, all such improvements and modifications are within the protection scope defined by the appended claims.

1. A method of interface filtering, the method comprising:
receiving a selection instruction from a user, selecting a text information to be operated, and operating a page of the text information;
calling a menu display option list including all operation functions of the text information when the operation is a preset operation, wherein the menu display option list comprises a function option of information hiding setting;
popping up a dialog box for setting hidden information when the function option of information hiding setting is selected;
setting a time period for information to be hidden in the dialog box according to an instruction of the user, wherein the time period comprises a start time stamp and an end time stamp;
redisplaying the page according to the time period of the hidden information set by the user; and
saving the time period set for the hidden information.

2. The method of interface filtering according to claim 1, wherein the redisplaying comprises:
hiding the information to be hidden of the time period set by the user; and
redisplaying the text information remaining after hiding.

3. The method of interface filtering according to claim 1, wherein the saving the time period set for the hidden information comprises:
saving the start time stamp and the end time stamp set for the hidden information.

4. A method of interface filtering, the method comprising:
calling a menu display option list according to an operation of a user, wherein the menu display option list comprises a function option of information hiding setting;
according to a setting instruction from the user, selecting the function option of information hiding setting from the menu display option list, and setting a time period of information to be hidden;
redisplaying a page according to the time period of the hidden information set by the user; and
saving the time period set for the hidden information.

5. The method of interface filtering according to claim 4, wherein the calling a menu display option list comprises:
receiving a selection instruction from a user, selecting a text information to be operated, and operating a page of the text information; and
calling the menu display option list including all operation functions of the text information when the operation is a preset operation.

6. The method of interface filtering according to claim 4, wherein the selecting comprises:
popping up a dialog box for setting the hidden information when the function option of information hiding setting in the menu display option list is selected; and
setting a start time stamp and an end time stamp for the information to be hidden in the dialog box according to an instruction of the user.

7. The method of interface filtering according to claim 4, wherein the redisplaying comprises:
hiding the information to be hidden of the time period set by the user; and
redisplaying the text information remaining after hiding.

8. The method of interface filtering according to claim 4, wherein the saving comprises:
saving the start time stamp and the end time stamp set for the hidden information.

9. A system of interface filtering, the system comprising:
a processor;
a computer readable storage medium; and
a computer program, wherein the computer program is stored in the storage medium, and configured to be loaded by the processor and to execute the following steps:
calling a menu display option list according to an operation of a user, wherein the menu display option list comprises a function option of information hiding setting;
according to a setting instruction from the user, selecting the function option of information hiding setting from the menu display option list, and setting a time period of information to be hidden;
redisplaying a page according to the time period of the hidden information set by the user; and
saving the time period set for the hidden information.

10. The system of interface filtering according to claim 9, wherein the calling a menu display option list comprises:
receiving a selection instruction from a user, selecting a text information to be operated, and operating a page of the text information;
calling the menu display option list including all operation functions of the text information when the operation is a preset operation.

11. The system of interface filtering according to claim 9, wherein the selecting comprises:
popping up a dialog box for setting the hidden information when the function option of information hiding setting is selected; and
setting a start time stamp and an end time stamp for the information to be hidden in the dialog box according to an instruction of the user.

12. The system of interface filtering according to claim 9, wherein the redisplaying comprises:
hiding the information to be hidden of the time period set by the user; and
redisplaying the text information remaining after hiding.

13. The system of interface filtering according to claim 9, wherein the saving comprises:
saving the start time stamp and the end time stamp set for the hidden information.

14. The method of interface filtering according to claim 1, further comprising:
directly calling a saved time period of the hidden information when logging in again; and
displaying a page of text information according to the saved time period of the hidden information.

15. The method of interface filtering according to claim 4, further comprising:
directly calling a saved time period of the hidden information when logging in again; and
displaying a page of text information according to the saved time period of the hidden information.

16. The system of interface filtering according to claim 9, wherein the computer program is further configured to execute the steps:
directly calling a saved time period of the hidden information when logging in again; and
displaying a page of text information according to the saved time period of the hidden information.

17. The method of interface filtering according to claim 1, wherein the text information comprises contents on a chat display interface of a chatting tool.

18. The system of interface filtering according to claim 5, wherein the text information comprises contents on a chat display interface of a chatting tool.

19. The system of interface filtering according to claim 10, wherein the text information comprises contents on a chat display interface of a chatting tool.

20. The system of interface filtering according to claim 1, wherein the preset operation is an operation set by the user.
